(19) United States
(12) Patent Application Publication
(10) Pub. No.: US 2015/0255984 A1
(43) Pub. Date: Sep. 10, 2015

(54) VEHICLE-TO-GRID SYSTEM CONTROL BASED ON STATE OF HEALTH

(71) Applicant: Nissan North America, Inc., Franklin, TN (US)

(72) Inventor: Kazuyuki Higashi, Farmington Hills, MI (US)

(73) Assignee: Nissan North America, Inc., Franklin, TN (US)

(21) Appl. No.: 14/197,651

(22) Filed: Mar. 5, 2014

(51) Int. Cl. H02J 4/00; G05B 15/02; G05F 1/66

(52) U.S. Cl. CPC H02J 4/00; G05F 1/66; G05B 15/02

(57) ABSTRACT

A vehicle-to-grid system for supplying electrical power to a power grid includes a group of vehicle charging systems and a vehicle-to-grid controller. Each vehicle charging system is associated with a respective vehicle and each vehicle charging system is operable to determine a state of health for a battery of the respective vehicle. The vehicle-to-grid controller is operable to receive state of health information for each respective vehicle from each vehicle charging system of the group of vehicle charging systems describing the state of health for the battery of the respective vehicle, and determine a maximum power supply value for the group of vehicle charging systems based in part on the state of health information for each respective vehicle.

### BACKGROUND

Electrical power is delivered from power generation facilities (i.e. power plants) to consumers by a system of transmission lines and transmission facilities referred to as a power grid. Power generation facilities generate electrical power at a near constant rate. Demand for electrical power, however, fluctuates. To address this issue, power storage facilities are connected to the power grid. During times at which the amount of electrical power that is generated exceeds the amount of electrical power that is consumed, power is stored by the power storage facilities. The power storage facilities return power to the power grid during times at which the demand for electrical power exceeds the amount being generated. Many different systems are used to store electrical power, including systems that store power by pumping water, compressing gases, charging batteries, and spinning flywheels.

Currently, electric vehicles are becoming common. Electric vehicles commonly include battery packs that are charged when the vehicle is not in use. Vehicles are commonly parked most of the time, and in the case of electric vehicles, the vehicle is connected to a charging system for much of the time it is parked. Vehicle-to-grid systems intend to take advantage of this situation by utilizing the batteries of electric vehicles for grid power storage, operating in a manner similar to traditional power storage facilities. Thus, in a vehicle-to-grid system, charging is managed, to the extent practical, such that charging occurs primarily when overall demand for electrical power from the grid is low. During peak demand times, electrical power can be returned to the grid from the batteries of the electric vehicle. Power losses can, however, occur during return of electrical power to the grid from the batteries of the electric vehicle, which diminishes the benefits of participation in the vehicle-to-grid system by the electric vehicle. In order to regulate a power-grid, however, the amount of power returned to the grid must be monitored to balance supply and demand.

### SUMMARY

The disclosure relates to vehicle-to-grid system control based on state of health.

One aspect of the disclosed embodiments is a vehicle-to-grid system for supplying electrical power to a power grid. The system includes a group of vehicle charging systems and a vehicle-to-grid controller. Each vehicle charging system is associated with a respective vehicle and each vehicle charging system is operable to determine a state of health for a battery of the respective vehicle. The vehicle-to-grid controller is operable to receive state of health information for each respective vehicle from each vehicle charging system of the group of vehicle charging systems describing the state of health for the battery of the respective vehicle, and determine a maximum power supply value for the group of vehicle charging systems based in part on the state of health information for each respective vehicle.

Another aspect of the disclosed embodiments is a vehicle-to-grid system for supplying electrical power to a power grid. The system includes a vehicle-to-grid controller that is operable to receive, from a group of vehicle charging systems each associated with a respective vehicle, state of health information for each respective vehicle from each vehicle charging system of the group of vehicle charging systems describing the state of health for a battery of the respective vehicle, and determine a maximum power supply value for the group of vehicle charging systems based in part on the state of health information for each respective vehicle.

Another aspect of the disclosed embodiments is a method for supplying electrical power to a power grid. The method includes determining, by each vehicle charging system from a group of vehicle charging systems, a state of health for a battery of a respective vehicle. The method also includes receiving, at a vehicle-to-grid controller from each vehicle charging system, state of health information describing the state of health for the battery of the respective vehicle. The method also includes determining, by the vehicle-to-grid controller, a maximum power supply value for the group of vehicle charging systems based in part on the state of health information for each respective vehicle.

### BRIEF DESCRIPTION OF THE DRAWINGS

The description herein makes reference to the accompanying drawings wherein like reference numerals refer to like parts throughout the several views, and wherein:

FIG. 1 is an illustration showing a vehicle-to-grid system implemented in an example power grid;

FIG. 2 is a block diagram showing an example of vehicle-to-grid system control including coordination between a vehicle-to-grid controller of the vehicle-to-grid system and a third-party system;

FIG. 3 is a flowchart showing a process for vehicle-to-grid system control based on state of health; and

FIG. 4 is a graph showing individual maximum power supply values and a total maximum power supply value for a first vehicle, a second vehicle, a third vehicle, and a fourth vehicle.

### DETAILED DESCRIPTION

The batteries of an electric vehicle have a capacity, which represents the maximum amount of power that the battery can store at a given time. Rechargeable batteries have an original capacity when new, and that capacity decreases over time with repeated charge and discharge cycles. State of health is a metric that compares the current capacity of a battery to its original capacity.

In vehicle-to-grid systems, power is returned to a power grid from the batteries of electric vehicles. Vehicle-to-grid controllers are used to coordinate this return of power to the grid by a group of vehicles, which can include a large number of vehicles (e.g. thousands). In order to regulate the power grid a third-party system can negotiate and regulate return of power to the grid from many power storage facilities, including the vehicle-to-grid system. In order to maximize the extent to which the vehicle-to-grid system participates, the systems and methods herein determine the state of health of the batteries for each vehicle that will participate under the control of the vehicle-to-grid controller, and determine a maximum power supply value based in part on the state of health information for each vehicle. The systems and methods herein can further control return of electrical power to the power grid based in part on the state of health information.

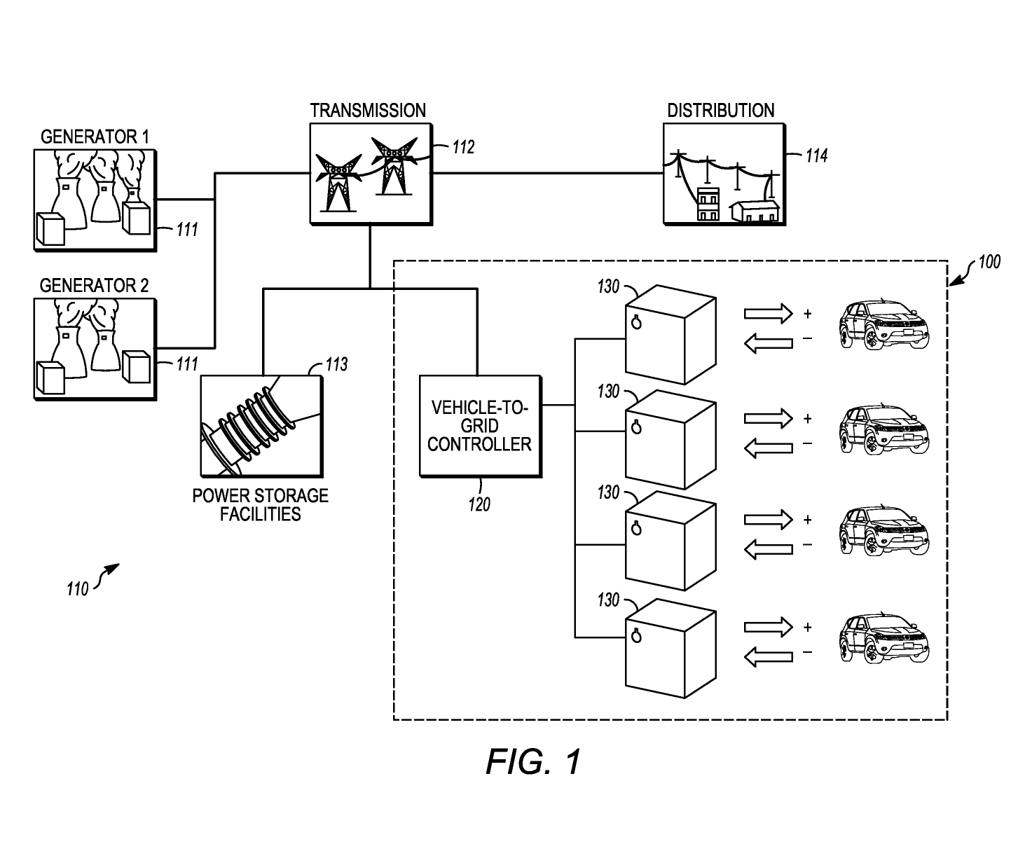

FIG. 1 shows a vehicle-to-grid system 100 and an example of an environment in which a vehicle-to-grid system 100 can be implemented. In the illustrated example, the vehicle-to-grid system 100 is implemented in the context of a power grid 110. Although the vehicle-to-grid system 100 can be implemented in the context of a power grid of any type of configuration, a typical power grid can include one or more power generation facilities 111 that generate and supply electrical power, a transmission network 112 that includes long-distance power lines, one or more power storage facilities 113 that receive and store electrical power when supply exceeds demand and return electrical power to the grid when demand exceeds supply, and a distribution network 114 that receives electrical power from the transmission network 112 and distributes electrical power to consumers such as businesses and homes.

The vehicle-to-grid system 100 includes a vehicle-to-grid controller 120, which may also be referred to herein as a controller. The vehicle-to-grid controller 120 is in communication with a plurality of vehicle charging systems or charging stations 130. The plurality of charging stations 130 is also referred to herein as a group of vehicle charging stations. The charging stations 130 need not be at a common geographical location, but rather can be at multiple locations. As an example, at least a first vehicle charging from the group of charging stations 130 can be at a different geographical location than a second vehicle charging station from the group of charging stations 130.

The vehicle-to-grid controller 120 is operable to receive information from the charging stations 130 and is further operable to send instructions to the charging stations 130. The instructions that are sent from the vehicle-to-grid controller 120 to the charging stations 130, when interpreted by each charging station, are operable to regulate operation of each charging station. For example, the instructions sent from the vehicle-to-grid controller 120 to the charging stations 130 can cause one or more of the charging stations to perform operations such as commencing supply of electrical power to the grid, commencing a charging operation, and altering characteristics by which power is supplied to the grid or consumed from the grid during a charging operation. The vehicle-to-grid controller 120 can be implemented in the form of a system that includes a processor that is operable to execute instructions that are stored on a computer readable storage device, such as RAM, ROM, a solid state memory device, or a disk drive. The vehicle-to-grid controller can further include a communications device for exchanging information with other computing devices via a communications network.

Each of the charging stations 130 is connected to the power grid in any suitable manner, is operable to receive electrical power from the power grid 110, and is also operable to supply electrical power to the power grid 110. The charging stations 130 are further in communication with the vehicle-to-grid controller 120 for sending information to the vehicle-to-grid controller 120 and receiving information and/or instructions from the vehicle-to-grid controller 120. As explained with respect to the vehicle-to-grid controller 120, the charging stations can each include a system that includes a processor that is operable to execute instructions that are stored on a computer readable storage device, which controls operation of each charging station 130. Each of the charging stations 130 can be an on-board charging station that is disposed within the vehicle and forms a part of the vehicle or may be an off-board charging station to which the vehicle is connected by, for example, a charging cable. In both cases, the charging stations are in communication with the vehicle-to-grid controller 120 by a wired communications link or a wireless communications link, where a wireless communication link is defined where no direct wired communication connection to the charging station 130 is required.

Each of the charging stations 130 can include a power converter that is operable, for example, to convert alternating current electrical power that is received from the grid to direct current electrical power that can be used for charging the batteries of a vehicle that is connected to the charging station, as well as to convert direct current electrical power as received from the vehicle into alternating current electrical power that can be returned to the power grid. The charging stations 130 are each operable to regulate the process by which power is converted. For example, each of the charging stations 130 can control the wave form of the alternating current power that is returned to the power grid, such as by modifying the frequency and/or wavelength of the alternating current electrical power.

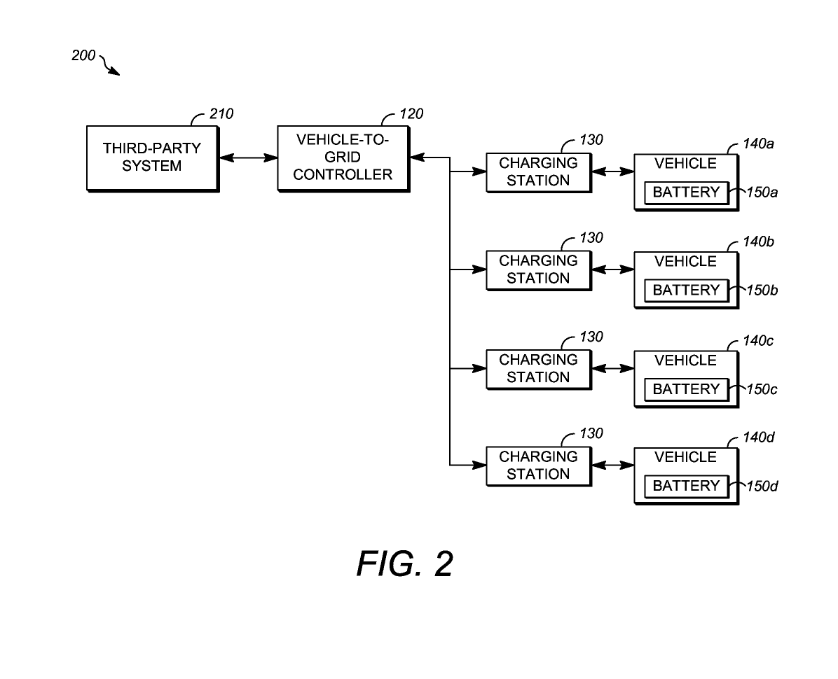

FIG. 2 is a block diagram showing an example 200 of vehicle-to-grid system control including coordination between the vehicle-to-grid controller 120 and a third-party system 210. As previously explained, the vehicle-to-grid controller 120 is in communication with a group of charging stations 130. Although four charging stations are shown in the illustrated example, any number (such as thousands) of charging stations can be included in the group of charging stations. Each of the charging stations 130 is associated with a respective vehicle, such as a first vehicle 140a having a battery 150a, a second vehicle 140b having a battery 150b, a third vehicle 140c having a battery 150c, and a first vehicle 140d having a battery 150d. The charging stations 130 are each associated with their respective vehicle by an electrical connection for performing charging and discharging operations, and the charging stations can be on-board or off-board, as previously explained. The charging stations 130 are all connected to the power grid 110.

Each charging station 130 is operable to determine a state-of-health for the battery of the respective vehicle to which it is connected. Each charging station 130 can be operable to determine state-of-health directly, or can be operable to receive state of health information from the respective vehicle, as determined by an on-board system of the respective vehicle. As used herein, state of health is determined by any method or system that measures or estimates the current maximum charge capacity of a battery pack relative to its ideal maximum charge capacity. As one example, measurable properties of a battery that degrade with use of the battery can provide a basis for estimating state-of-health. As another example, the number of charge-discharge cycles that a battery has gone through can provide a basis for estimating state-of-health.

The vehicle-to-grid controller 120 receives the state-of-health information for each of the batteries 150a-150d, from the respective one of the charging stations 130 that is associated with each of the vehicles 140a-140d. Based in part on the state of health information for the batteries 150a-150d for each respective vehicle, the vehicle-to-grid controller 120 is operable to determine a maximum power supply value for the group of charging stations 130. The maximum power supply value is an estimate representing the maximum amount of power that the vehicles 140a-140d can be expected to return to the power grid 110 during a peak demand time when demand for electrical power is greater than supply from the power generation facilities 111.

As an example, the maximum power supply value can be determined as a sum of the expected maximum power contribution for each of the vehicles 140a-140d. The expected maximum power contribution for each vehicle is based at least in part on an original power capacity of the battery of the vehicle, and the current state of health of the battery. Thus, in a system that determines expected maximum power contribution for each vehicle based solely on the original power capacity and the current state of health, for a battery having an original power capacity of 20 kWh and a current state of health of 50%, the expected maximum power contribution would be 10 kWh. The expected maximum power contribution for each vehicle can be determined further based on other factors, such as the current state of charge of the battery. After the expected maximum power contribution for each vehicle is computed, the sum of these values is used as the maximum power supply value, or used as a basis for determining the maximum power supply value, such as by modifying this sum according to additional factors.

The vehicle-to-grid controller 120 is operable to transmit information describing the maximum power supply value to the third-party system 210. The third-party system 210 can be, for example, a system or portion of a system that regulates return of power to the power grid by one or more power storage facilities, including the vehicle-to-grid system 100. In response to receiving the information describing the maximum power supply value, the third-party system can transmit, to the vehicle-to-grid controller 120, information describing a requested power supply value. The requested power supply value is an amount of power to be returned to the grid by the vehicle-to-grid system 100. The requested power supply value can be determined by the third-party system based on, for example a current demand for electrical power on the power grid 110 and the maximum power supply value. Thus, for example, the requested power supply value can be less than or equal to the maximum power supply value.

The vehicle-to-grid controller 120 can transmit instructions to each of the charging stations 130. The instructions, when processed by each of the charging stations 130, cause each of the respective vehicles 140a-140d to supply electrical power to the power grid. The instructions can specify an amount of power to be returned to the grid by each of the vehicles 140a-140d. In one implementation, the instructions can cause each of the vehicles 140a-140d to return an amount of electrical power to the power grid 110 that is equal to a respective portion of the requested power supply value, where the respective portion for a particular vehicle is based on the state of health information for the vehicle. The respective portion of the requested power supply value for each vehicle can be determined on a pro rata basis, taking the state of health for each vehicle into account. For example, since a percentage of the maximum power supply value is attributable to each vehicle, the same percentages can be applied to the requested power supply value to determine the requested portion for each vehicle. Thus a vehicle having a lowest state of health among the group of vehicles 14a-140d would be requested to supply a smallest respective portion of the requested power supply value.

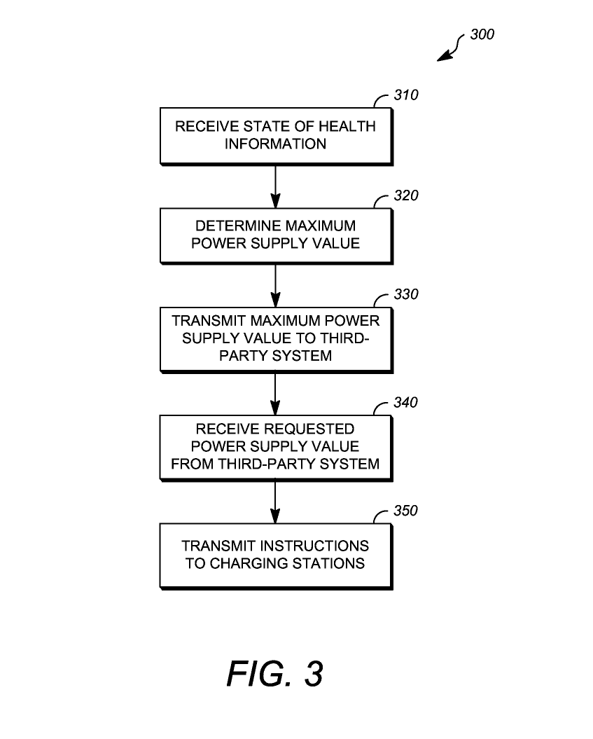

FIG. 3 is a flowchart showing a process 300 for vehicle-to-grid system control based on state of health.

Initially, each of charging station 130 determines the state of health for one of the batteries 150a-150d of a respective one of the vehicles 140a-140d. This information is transmitted from the charging stations 130 to the vehicle-to-grid controller 120 and is received by the vehicle-to-grid controller 120 in operation 310. In operation 320, the vehicle-to-grid controller 120 determines the maximum power supply value, as previously described. In operation 330, the vehicle-to-grid controller 120 transmits the maximum power supply value to the third-party system 210. The third-party system 210 determines a requested power supply value, which is transmitted to the vehicle-to-grid controller 120 and is received at the vehicle-to-grid controller at operation 340. In operation 350, the vehicle-to-grid controller 120 transmits instructions to the charging stations 130 for causing the vehicle-to-grid controller 120 to return power from the batteries 150a-150d of the vehicles 140a-140d to the power grid 110.

As an example, assume that each of the vehicles 140a-140d can supply a maximum of 10 kW of power to the grid at 100% state of health. Without controlling the power supplied by each vehicle based on its current state of health, a conservative value might be selected, such as supply of 5 kW of power, to prevent adverse effects with respect to vehicles having a low state of health. Thus, the four vehicles would each supply 5 kW of power, for a total of 20 kW. As a result, the maximum benefit is not received from those vehicles having a state of health greater than 50%, and those vehicles with a state of health less than 50% could suffer faster than normal battery degradation.

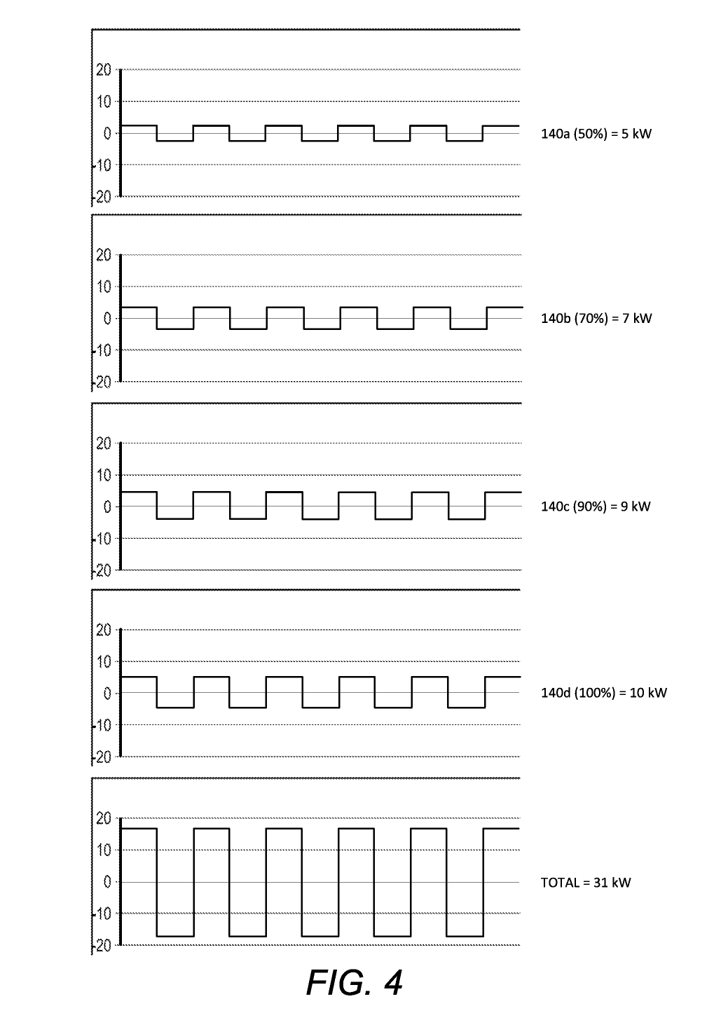

According to the systems and methods herein, however, the charging stations 130 determine the state of health for each of the vehicles 140a-140d. In this example, assume that the first vehicle 140a has a state of health of 50%, the second vehicle 140b has a state of health of 70%, the third vehicle 140c has a state of health of 90%, and the fourth vehicle 140d has a state of health of 100%. The vehicle-to-grid controller 120 determines that the first vehicle 140a can supply 5 kW of power, the second vehicle 140b can supply 7 kW of power, the third vehicle 140c can supply 9 kW of power, and the fourth vehicle 140d can supply 10 kW of power, as shown in FIG. 4. Based on these values, the vehicle-to-grid controller 120 determines a total power supply value of 31 kW, and transmits information to the third-party system 210. In response, if the third-party system 210 requests 31 kW of power, the vehicle-to-grid controller 120 transmits instructions to the charging stations 130 that cause the first vehicle 140a to supply 5 kW of power, cause the second vehicle 140b to supply 7 kW of power, cause the third vehicle 140c to supply 9 kW of power, and cause the fourth vehicle 140d to supply 10 kW of power. Alternatively, if the third-party system 210 requests 15.5 kW of power, the vehicle-to-grid controller 120 determines a respective portion for each of the vehicles 140a-d, such as on a pro-rata basis, and transmits instructions to the charging stations 130 that cause the first vehicle 140a to supply 2.5 kW of power, cause the second vehicle 140b to supply 3.5 kW of power, cause the third vehicle 140c to supply 4.5 kW of power, and cause the fourth vehicle 140d to supply 5 kW of power.

While the description herein is made with respect to specific implementations, it is to be understood that the invention is not to be limited to the disclosed implementations but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A vehicle-to-grid system for supplying electrical power to a power grid, comprising:
a group of vehicle charging systems, each vehicle charging system associated with a respective vehicle and each vehicle charging system operable to determine a state of health for a battery of the respective vehicle; and
a vehicle-to-grid controller that is operable to receive state of health information for each respective vehicle from each vehicle charging system of the group of vehicle charging systems describing the state of health for the battery of the respective vehicle, and determine a maximum power supply value for the group of vehicle charging systems based in part on the state of health information for each respective vehicle.

2. The vehicle-to-grid system of claim 1, wherein the vehicle-to-grid controller is further operable to send instructions to the group of vehicle charging systems that, when processed, cause each of the vehicle charging systems to supply electrical power to the power grid from the battery of the respective vehicle.

3. The vehicle-to-grid system of claim 2, wherein the instructions cause each vehicle to supply electrical power to the power grid as a respective portion of a requested power supply value, wherein the respective portion is based on the state of health information for the respective vehicle.

4. The vehicle-to-grid system of claim 3, wherein the respective portion of the requested power supply value for each vehicle is based further in part on an original capacity for the battery of the respective vehicle.

5. The vehicle-to-grid system of claim 3, wherein the vehicle-to-grid controller is operable to transmit, to a third-party system, information describing the maximum power supply value, and receive from the third-party system, information describing the requested power supply value.

6. The vehicle-to-grid system of claim 5, wherein the requested power supply value is less than or equal to the maximum power supply value.

7. The vehicle-to-grid system of claim 3, wherein the respective portion of the requested power supply value for each vehicle is determined based on the state of health of the respective vehicle.

8. The vehicle-to-grid system of claim 7, wherein a respective vehicle having a lowest state of health corresponds to a smallest respective portion of the requested power supply value.

9. The vehicle-to-grid system of claim 1, wherein at a first vehicle charging system from the group of vehicle charging systems is at a different geographical location than a second vehicle charging system from the group of vehicle charging systems.

10. The vehicle-to-grid system of claim 1, wherein each vehicle charging system from the group of vehicle charging systems is at least one of an on-board vehicle charging system or an off-board vehicle charging system.

11. A vehicle-to-grid system for supplying electrical power to a power grid, comprising:
a vehicle-to-grid controller that is operable to receive, from a group of vehicle charging systems each associated with a respective vehicle, state of health information for each respective vehicle from each vehicle charging system of the group of vehicle charging systems describing the state of health for a battery of the respective vehicle, and determine a maximum power supply value for the group of vehicle charging systems based in part on the state of health information for each respective vehicle.

12. The vehicle-to-grid system of claim 11, wherein the vehicle-to-grid controller is further operable to send instructions to the group of vehicle charging systems that, when processed, cause each vehicle charging system to supply electrical power to the power grid from the battery of the respective vehicle.

13. The vehicle-to-grid system of claim 12, wherein the instructions cause each vehicle to supply electrical power to the power grid as a respective portion of a requested power supply value, wherein the respective portion is based on the state of health information for the respective vehicle.

14. The vehicle-to-grid system of claim 13, wherein the respective portion of the requested power supply value for each vehicle is based further in part on an original capacity for the battery of the respective vehicle.

15. The vehicle-to-grid system of claim 13, wherein the vehicle-to-grid controller is operable to transmit, to a third-party system, information describing the maximum power supply value, and receive from the third-party system, information describing the requested power supply value.

16. The vehicle-to-grid system of claim 15, wherein the requested power supply value is less than or equal to the maximum power supply value.

17. The vehicle-to-grid system of claim 13, wherein the respective portion of the requested power supply value for each vehicle is determined based on the state of health of the respective vehicle.

18. The vehicle-to-grid system of claim 17, wherein a respective vehicle having a lowest state of health corresponds to a smallest respective portion of the requested power supply value.

19. A method for supplying electrical power to a power grid, comprising:
determining, by each vehicle charging system from a group of vehicle charging systems, a state of health for a battery of a respective vehicle;
receiving, at a vehicle-to-grid controller from each vehicle charging system, state of health information describing the state of health for the battery of the respective vehicle; and
determining, by the vehicle-to-grid controller, a maximum power supply value for the group of vehicle charging systems based in part on the state of health information for each respective vehicle.

20. The method of claim 19, further comprising:
transmitting, from the vehicle-to-grid controller to each vehicle charging system from the group of vehicle charging systems, instructions that when processed cause each of the vehicle charging systems to supply electrical power to the power grid from the battery of the respective vehicle, wherein the instructions cause each vehicle to supply electrical power to the power grid as a respective portion of a requested power supply value, wherein the respective portion is based on the state of health information for the respective vehicle.
